(19) United States
(12) Patent Application Publication
(10) Pub. No.: US 2005/0216251 A1
(43) Pub. Date: Sep. 29, 2005

(54) BI-LINGUAL LANGUAGE DISPLAY AND METHOD

(76) Inventor: Kirk Dean Dorius, Chandler, AZ (US)

Correspondence Address: SNELL & WILMER;ONE ARIZONA CENTER, 400 EAST VAN BUREN, PHOENIX, AZ, 850040001, US

(21) Appl. No.: 10/907,216

(22) Filed: Mar. 24, 2005

Related U.S. Application Data
(60) Provisional application No. 60/556,245, filed on Mar. 24, 2004.

(51) Int. Cl. G06F 17/28

(52) U.S. Cl. 704/2

(57) ABSTRACT

A coordinated language display and method including visual coordination of grammatical concepts, language structures or forms between and/or within texts. Visual coordination may be accomplished by altering the visual textual attributes of certain words or textual units or by associating an indicator of the relationship or grammatical function of the words, for example, with characters or symbols indicating the person, number, mood and/or tense of verbs.

### CROSS-REFERENCE TO RELATED APPLICATIONS

This application claims benefit from and priority to U.S Provisional Patent Application Ser. No. 60/556,245, filed Mar. 24, 2004, which is hereby incorporated by reference in its entirety.

### FIELD OF INVENTION

The present invention relates to language displays and methods of visually coordinating and displaying grammatical concepts, language structures, word relationships, definitions, and/or verb tenses in texts, for example, in bilingual texts.

### BACKGROUND OF INVENTION

Conventional narrative texts and novels exercise a reader's preexisting grammatical proficiency and provide any additional grammatical instruction only indirectly or implicitly. Formal grammatical instruction typically entails deconstructing or diagramming phrases and sentences rather than reading full narrative texts. Similarly, foreign language studies are typically centered, at least initially, around short phrases or passages. Full foreign narrative texts comparable to those read in one's native language often seem daunting if not insurmountable to beginning foreign language students.

To work through such foreign texts, foreign language students typically must rely on multiple reference guides, such as dictionaries, verb conjugation guides, and/or grammar guides. Many students weary, however, of pausing to flip between and through multiple reference books after each new word or phrase, sometimes abandoning their foreign language studies altogether.

There is, therefore, a need for an easily understandable method of expressly conveying grammatical, definitional, and/or verb conjugation information in bilingual or foreign texts without undue disruption of the readability or message of the text. There is further a need for a single, integrated medium containing multiple language texts for reading by language students that reduces the need for outside references.

### SUMMARY OF INVENTION

The invention provides both native language and foreign language students the benefits of express, ongoing, digestible grammatical instruction within full narrative texts. An exemplary embodiment of the present invention includes a bilingual language display having verbs and nouns visually coordinated between the two language texts with superscript indicators of the person, number, and tense of each coordinated verb in the foreign language text. An exemplary method includes displaying grammatical concepts in multiple texts by positioning discrete passages of a first language text adjacent discrete passages of a second language translation of the first text and visually coordinating grammatical concepts within and between the two texts.

Visual coordination of grammatical concepts is accomplished, for example, by varying a font, font size, color, style, shading, highlighting or other visual textual attribute or effect. For example, verbs in both language texts may be coordinated by displaying them in italics, while nouns may be displayed in all caps, reducing the need to consult a dictionary because of the ease of identifying corresponding verbs or nouns in the first language text.

Additional indicators such as symbols or characters may accompany and explain verb conjugations. For example, superscript characters may accompany verb forms to indicate the tense, person, and/or number of a verb conjugation, reducing or obviating the need to consult a conjugation guide. Adjectives, adverbs or other parts of speech may be similarly coordinated with different visual characteristics, enabling readers to easily comprehend individual foreign words and phrases, without the need for external reference materials.

Such visual coordination and supplemental indicators enable a reader to readily find the corresponding noun or verb in a first or second language text because of the finite number of coordinated words, the positional relationship of the discrete passages on the page, and the contextual relationship of the coordinated words in each of the two texts.

The invention is applicable to both printed and electronic texts. For example, the above described coordination and indicators may also be applied as electronic tags for interactive instruction or for database manipulation or for reference by computer software. Recorded audio clips may be associated with discrete words or passages of either or both texts to provide examples of pronunciation, accent, inflection, and the like.

When reading unfamiliar words and grammatical structures in the foreign language portion, language students may benefit from an understanding of the storyline and context gained from having read the native language portion. By referring first to the native language portion, a reader previews the vocabulary and parts of speech to be encountered in the corresponding foreign language portion. This reduces the need to refer back to the native portion of the text to understand the second language portion. Visual coordination of parts of speech enables readers to identify corresponding words in both languages, obviating the need for constant reference to a dictionary. Indication of the person, number, and tense of verbs further increases the reader's comprehension and further reduces the need for external reference materials.

### BRIEF DESCRIPTION OF THE DRAWINGS

FIG. 1 illustrates an exemplary language display according to one embodiment of the invention.

FIG. 2 is an exemplary key showing exemplary indicators useful to show the person, number, and tense of various verb conjugations in the exemplary language display of FIG. 1.

### DETAILED DESCRIPTION

The detailed description of exemplary embodiments of the invention herein makes reference to the accompanying figures, which show exemplary embodiments by way of illustration and their best mode. While these exemplary embodiments are described in sufficient detail to enable those skilled in the art to practice the invention, it should be understood that other embodiments may be realized and that changes may be made without departing from the spirit and scope of the invention. Thus, the detailed description herein is presented for purposes of illustration only and not of limitation.

The invention provides visual coordination of various parts of speech or other grammatical concepts between and/or within two discrete language portions of a bilingual text. For example, nouns, adjectives, verbs, and adverbs may be coordinated as categories by distinguishing certain visual attributes of textual units, i.e., words, phrases, or clauses within a portion of the bilingual text. For example, the font, font size, color, style, shading, highlighting or other visual textual attribute may be modified or distinguished to coordinate various grammatical concepts. Grammatical concepts include the structural relationship of words, parts of speech, idioms, verb use, syntax, rules of language formation, morphology, and semantics.

Added characters or symbols may be used to provide additional information about the role or relationship of words or textual units within the text. For example, verbs may be identified by associated symbols or characters indicating the person, number, tense and/or mood of the verb. Various roles of verb forms such as verb roots, infinitives, gerunds, past participles and the like may be similarly identified.

Any grammatical concept, form, relationship, structure or syntax may be thus visually identified or coordinated using the present invention, including, but not limited to: nouns, adjectives, verbs, adverbs, gender, number, person, moods, tenses, declensions, irregular forms, cases (e.g., nominative, accusative, dative, genitive), articles, demonstratives, superlatives, comparatives, subjects, objects, indirect objects, reflexive forms, possessives, relative pronouns, indefinite pronouns, interrogative pronouns, imperatives, subjunctive moods, conditional moods, modal verbs, prepositions, conjunctions, contractions, idiomatic expressions, synonyms, antonyms, or mathematical concepts (e.g., cardinal or ordinal numbers), and the like.

According to various embodiments of the present invention, coordination of grammatical concepts is accomplished by use of characters or symbols associated with textual units representing words, word roots, phrases, or clauses embodying those concepts. Such characters may be visible to aid a reader in identifying different grammatical concepts embodied in a text. In electronic form, these characters and symbols may also be non-visual identifiers tying these textual units to a database or as references for use or manipulation by computer software. Sound bites, pictures, video clips and other multimedia files may be associated with instances of various textual units or grammatical concepts. Such multimedia files may be invoked automatically or selectively by a user. For example, a reader may read a first language text portion, and may then play a sound recording of the corresponding second language text portion while she reads along or practices pronunciation.

It should be understood that the separate language portions of a bilingual text may be associated in any suitable manner. For example, the second language portion may be placed adjacent the first language portion in columns or in alternating rows and the like. The body of the text may be separated into discrete passages to facilitate easier pairing of correlated words within paired passages. In an electronic version, the display may alternate between the first and second language portions.

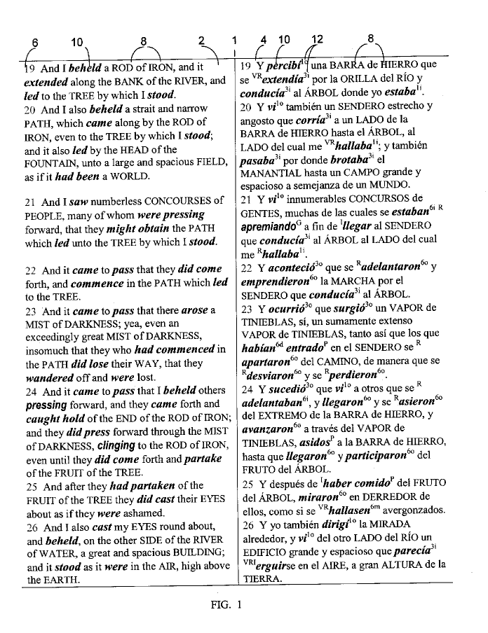

Referring to the exemplary embodiment shown in FIG. 1, a bilingual language display 1 includes a first language text 2 positioned adjacent a second language translation 4 of first language text 2. Texts 2 and 4 may be parsed into discrete passages 6 of paragraphs, sentences, phrases or the like, with corresponding passages 6 in each language positioned side by side in separate columns on a page. The nouns 8, excluding pronouns and proper nouns, are coordinated in a first font, font size and/or style (e.g., all caps). The verbs 10 are in a second font, font size and/or style (e.g., bold and italics). Suitable coordinating styles include any visual textual attribute or effect applied to text. Adverbs and adjectives may similarly be visually coordinated between the two columns. These four categories: nouns 8, verbs 10, adjectives, and adverbs make up the majority of the expressive content in a text. Any parts of speech or grammatical concepts such as prepositions and conjunctions may also be selectively coordinated. For example, different parts of speech or grammatical concepts may be coordinated in different passages or sections of the text. In this way, grammatical instruction may progress as the narrative progresses.

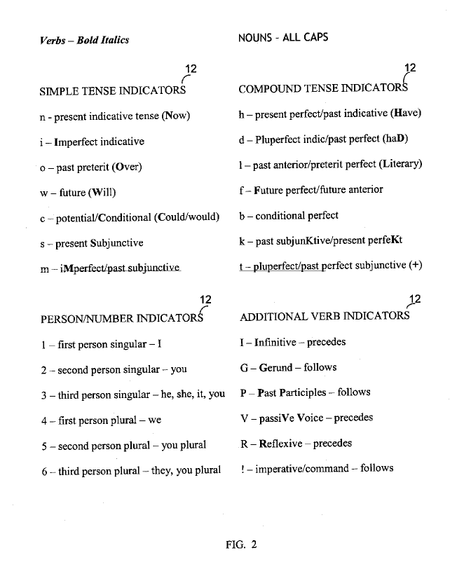

With continued reference to FIG. 1, the person and number of various verb conjugations are indicated by indicators 12 comprising numeric characters (1-6) and various letters. With reference now to FIG. 2, various examples of indicators 12 are shown: number (1) is equated to first person singular, number (2) to second person singular, number (3) to third person singular, number (4) to first person plural, number (5) to second person plural, and number (6) to third person plural. With continued reference to exemplary indicators 12 in FIG. 2: simple verb tenses may be indicated by lowercase letters without stems. For example, “n” represents the present indicative, “i” the imperfect indicative, “o” the past preterit, “w” the future, “c” the potential or conditional, “s” the present subjunctive, and “m” the imperfect or past subjunctive. Compound verb tenses may similarly be indicated by lowercase letters with stems. For example, “h” represents the present perfect or past indicative, “d” the pluperfect indicative or past perfect, “I” the past anterior or preterit perfect, “f” the future perfect or future anterior, “b” the conditional perfect, “k” the past subjunctive or present perfect, and “t” the pluperfect or past perfect subjunctive. Other indicators 12 may include “I” for infinitives, “G” for gerunds, “P” for past participles, “V” for passive voice, “R” for reflexive forms, and “!” for imperative voice.

Indicators 12 may precede or follow or may be otherwise suitably associated with the identified word or grammatical concept. Superscript or subscript characters may be used to distinguish indicators 12 from the original text.

It should be understood that any character, symbol, or marking may be used as indicator 12. Different colors or shading may be used to highlight examples of various grammatical concepts or to highlight portions of text that are colloquially different between the two texts. Underlining or shading may be used to group words that have a distinct idiomatic or collective meaning. Any means of distinguishing a textual unit, whether now known or later developed, may be used to visually coordinated grammatical concepts according to the invention. Similarly, any character, symbol, marking, electronic tag, link, or other suitable means now known or later develop, may be used as an indicator as described herein.

Various embodiments include superscript or subscript characters or symbols indicating a specific grammatical concept embodied by a word, word root, or word group. For example, a conjugated verb may be preceded or followed by a superscript or subscript symbol or character indicating the person, number, tense and/or mood of the verb. Similarly, character or symbol indicators may be used to identify infinitives, gerunds, past participles, passive voice, reflexive forms, imperatives, exceptions to general rules, or examples of specific grammatical concepts. Such indicators may also be used to distinguish between the different grammatical uses of words, e.g., to differentiate between a past participle used in a compound verb and one used as an adjective. Word groups having a collective or colloquial meaning may be formatted or altered or supplemented collectively to be coordinated with other similar groups within or between the two language texts. Sound recordings of the foreign language may be associated with discrete portions of the text and selectively played to precede or accompany the reading of the corresponding portion of the text.

Readers can thus study the meanings of the visual coordination and indicators along with the substance of the text, or may simply absorb this additional information subconsciously while reading for content. This method allows language students to more easily acquire and retain an understanding of foreign language structures, verb conjugations, and vocabulary within the context of a full narrative text.

An exemplary method of displaying language structure includes visual coordination of grammatical concepts, language structures, verb tenses or modes, comprising the steps of (1) parsing text into individual textual units representing words, word roots, phrases, or clauses, (2) comparing the textual units to predetermined categories of words, word roots or phrases arranged according to a common grammatical function or concept (3) and visually coordinating textual units according to at least one common grammatical function or concept.

In another exemplary method, first and second language texts are parsed into textual units (e.g., individual words). Listings of all unique words found in each text may thus be formed. Punctuation or other characters may be used or ignored in parsing the text. These listings are then compared to an existing database listing of words or other textual units arranged around common parts of speech or other grammatical concepts. This may be accomplished with a routine similar to that used to identify the unique words in the text. Any unique words not found in existing category listings may then be coded appropriately and added to the database listings. Verbs may be listed by common ending so as to be grouped according to common conjugations. Properties such as styles (e.g., bold, underline, italics) or concept indicators may then be applied to any or all words or other textual units within a particular category. For example, the font of all adverbs in the first or second language text may be selected to be different than the remainder of the text. Similarly, styles, fonts, colors, and the like may be applied to any other grouping of words throughout the first and/or second language text portions. Words found in more than one category may be identified for subsequent coding based on more complex grammatical rule sets.

Additional indicators may be applied to verbs to explain conjugations (e.g., person, number, and tense) or to other textual units to explain the relevant case (e.g., nominative, dative, genitive), and the like. A macro or other basic routine may be used to apply the desired indicators to any or all incidents of any given textual unit or category of words in the first or second language text portions. Exemplary indicators are shown in FIG. 2 as discussed above. It is understood that the method may be applied to any number of texts in any number of languages and that any number of language texts may be associated together with common visual coordination of parts of speech and indicators.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the invention. The scope of the present invention is accordingly to be limited by nothing other than the appended claims, in which reference to an element in the singular is not intended to mean “one and only one” unless explicitly so stated, but rather “one or more.” Further, no element described herein is required for the practice of the invention unless expressly described as “essential” or “critical.”

1. A bilingual language display comprising:
a first text in a first language;
a second text comprising a translation of said first text;
a visual coordination of a part of speech between said first and second texts; and
an indicator of a verb form in at least one of said first and second texts.

2. The language display of claim 1, wherein said indicator of said verb form includes an indication of at least one of the number, person, mood and tense of said verb form.

3. The language display of claim 1, wherein said visual coordination comprises modification of at least one of the font, font size, style, bold, italics, capitalization, color, shading, highlighting, and character weight of a textual unit comprising said part of speech.

4. The language display of claim 1, wherein said second text is arranged in discrete passages associated with corresponding discrete passages of said first text.

5. The language display of claim 1, wherein said visual coordination of a part of speech is displayed both within and between said first and second texts.

6. The language display of claim 1, wherein multiple indicators of said verb form serve as said visual coordination of said verb form as said part of speech, each of said multiple indicators indicating at least one of the person, number, tense, conjugation, use and mood of said verb form.

7. A language display comprising:
a text;
a visual coordination of a part of speech within said text; and
an indicator of a verb form in said text.

8. The language display of claim 7, wherein said visual coordination comprises a distinguished visual textual attribute of a textual unit comprising said part of speech; and wherein said indicator comprises an indication of at least one of the number, person, tense, mood, role and conjugation of at least one of an infinitive, gerund, reflexive, passive, transitive, intransitive, imperative, and conjugated verb form.

9. A method of visually coordinating grammatical concepts in a bilingual text comprising:
displaying a first text in a first language;
displaying a second text, said second text comprising a translation of said first text; and
visually coordinating at least grammatical concept between said first and second texts.

10. The method of claim 9, further comprising:
providing an identification of at least one of the person, number, mood, conjugation, and tense of multiple verbs in at least one of said first and second texts.

11. The method of claim 9, wherein visually coordinating at least one part of speech comprises visually coordinating multiple verbs between said first and second texts; the method further comprising providing an identification of the person, number and tense of at least a portion of said coordinated multiple verbs.

12. The method of claim 9, further comprising providing an identification of at least one of a case, voice, infinitive, gerund, past participle, passive voice, reflexive form, and imperative.

13. The method of claim 9, wherein visually coordinating at least one part of speech between said first text and said second text comprises distinguishing at least one of the font, font size, font weight, color, highlighting, shading, and style of text corresponding to said at least one part of speech.

14. A method of displaying grammatical concepts comprising:
displaying a first language text;
displaying a second language text adjacent said first language text, said second language text comprising a translation of said first language text; and
visually coordinating at least one grammatical concept within at least one of said first and second texts.

15. The method of claim 14, further comprising visually coordinating at least one grammatical concept between said first text and said second text.

16. The method of claim 14, further comprising associating indicators with a verb form in at least one of said first and second texts to indicate at least one of the person, number, and tense of said verb form.

17. The method of claim 16, wherein the step of associating indicators with said verb form comprises displaying a first character to indicate the number and person and a second character to indicate the tense of said verb form.

18. The method of claim 14, wherein visually coordinating at least one grammatical concept comprises displaying an indicator associated with a verb form to indicate at least one of the person, number, mood and tense of said verb form.

19. The method of claim 14, wherein visually coordinating at least one grammatical concept comprises altering a visual textual attribute of a textual unit representing said grammatical concept in at least one of said first and second texts.

20. The method of claim 19, wherein altering a visual textual attribute comprises altering at least one of the color, shading, font, font size, style, character weight, capitalization, and highlighting of said textual unit.
